(19) United States
(12) Patent Application Publication
(10) Pub. No.: US 2026/0227612 A1
(43) Pub. Date: Aug. 6, 2026

(54) ZOOM OPTICAL SYSTEM, OPTICAL APPARATUS, AND METHOD FOR MANUFACTURING ZOOM OPTICAL SYSTEM

(71) Applicant: NIKON CORPORATION, Shinagawa-ku, Tokyo (JP)

(72) Inventors: Satoshi MIWA, Yokohama-shi (JP); Tomoyuki SASHIMA, Tokyo (JP)

(21) Appl. No.: 19/149,640

(22) PCT Filed: Dec. 20, 2023
(86) PCT No.: PCT/JP2023/045603

§ 371 Date: Jul. 21, 2025

(30) Foreign Application Priority Data
Jan. 24, 2023 (JP) 2023-008533

(51) Int. Cl. G02B 15/20; G02B 15/14

(52) U.S. Cl. CPC G02B 15/20; G02B 15/1461

(57) ABSTRACT

A zoom optical system exhibiting favorable optical performance while achieving weight and size reduction, an optical apparatus, and a method for manufacturing the zoom optical system are provided. A zoom optical system ZL included in an optical apparatus such as a camera 1 includes, sequentially from an object side, a first lens group G1 having positive refractive power, a second lens group G2 having negative refractive power, a middle lens group GM including one or two lens groups and having overall positive refractive power, a focusing lens group GF having negative refractive power and configured to move in an optical axis direction at focusing, and a final lens group GR having positive refractive power, a space between adjacent lens groups changes at zooming, the first lens group G1 is constituted by one single lens, and the zoom optical system ZL satisfies a condition expressed by a predetermined conditional expression.

### TECHNICAL FIELD

The present invention relates to a zoom optical system, an optical apparatus, and a method for manufacturing the zoom optical system.

### BACKGROUND ART

Recently, there has been a demand for weight and size reduction in zoom optical systems (refer to Patent Literature 1), and it has been desired to further improve optical performance while achieving weight and size reduction.

### CITATION LIST

### Patent Literature

Patent Literature 1: Japanese Patent Laid-open No. 2022-096075

### SUMMARY OF INVENTION

A zoom optical system according to a first aspect of the present invention includes, sequentially from an object side, a first lens group having positive refractive power, a second lens group having negative refractive power, a middle lens group including one or two lens groups and having overall positive refractive power, a focusing lens group having negative refractive power and configured to move in an optical axis direction at focusing, and a final lens group having positive refractive power, a space between adjacent lens groups changes at zooming, the first lens group is constituted by one single lens, and the zoom optical system satisfies a condition expressed by expressions below,

$$1.45 < nd 1 < 1.63$$

$$62.5 < vd 1 < 85.$$

in the expressions,
nd1: refractive index of a medium of the single lens constituting the first lens group at a d line, and
vd1: Abbe number of the medium of the single lens constituting the first lens group at the d line.

A method for manufacturing the zoom optical system according to the first aspect of the present invention is a method for manufacturing a zoom optical system including, sequentially from an object side, a first lens group having positive refractive power, a second lens group having negative refractive power, a middle lens group including one or two lens groups and having overall positive refractive power, a focusing lens group having negative refractive power and configured to move in an optical axis direction at focusing, and a final lens group having positive refractive power, the method including disposing the lens groups so that a space between adjacent lens groups changes at zooming, and disposing the first lens group to be constituted by one single lens that satisfies a condition expressed by expressions below,

$$1.45 < nd 1 < 1.63$$

$$62.5 < vd 1 < 85.$$

in the expressions,
nd1: refractive index of a medium of the single lens constituting the first lens group at a d line, and
vd1: Abbe number of the medium of the single lens constituting the first lens group at the d line.

### BRIEF DESCRIPTION OF DRAWINGS

FIG. 1 is a cross-sectional view showing a lens configuration of a zoom optical system according to a first example at focusing on an infinite distance object in a wide-angle end state.

FIG. 2 shows a variety of aberration diagrams of the zoom optical system according to the first example in the wide-angle end state.

FIG. 3 is a cross-sectional view showing a lens configuration of a zoom optical system according to a second example at focusing on an infinite distance object in a wide-angle end state.

FIG. 4 shows a variety of aberration diagrams of the zoom optical system according to the second example in the wide-angle end state.

FIG. 5 is a cross-sectional view showing a lens configuration of a zoom optical system according to a third example at focusing on an infinite distance object in a wide-angle end state.

FIG. 6 shows a variety of aberration diagrams of the zoom optical system according to the third example in the wide-angle end state.

FIG. 7 is a cross-sectional view of a camera on which an above-described zoom optical system is mounted.

FIG. 8 is a flowchart for description of a method for manufacturing the above-described zoom optical system.

### DESCRIPTION OF EMBODIMENTS

Preferable embodiments will be described below with reference to the accompanying drawings.

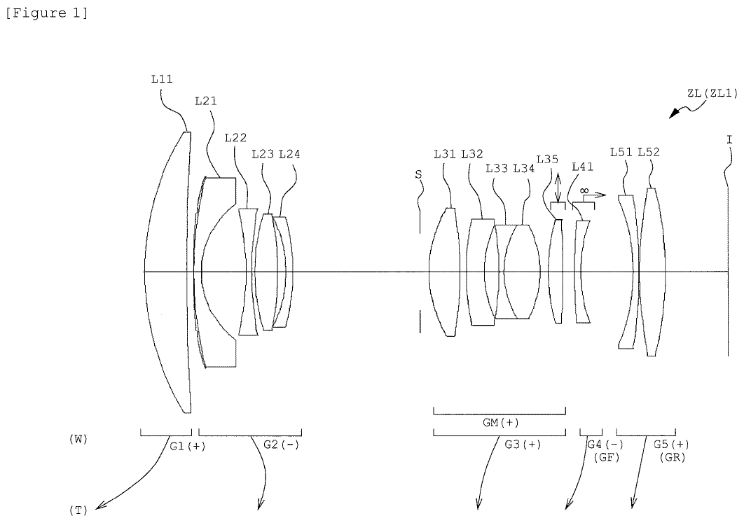

As shown in FIG. 1, a zoom optical system ZL according to the present embodiment includes, sequentially from an object side, a first lens group G1 having positive refractive power, a second lens group G2 having negative refractive power, a middle lens group GM including one or two lens groups and having overall positive refractive power, a focusing lens group GF having negative refractive power and configured to move in an optical axis direction at focusing, and a final lens group GR having positive refractive power. The space between adjacent lens groups changes at zooming. The first lens group G1 is constituted by one single lens L11. With this configuration, the zoom optical system ZL can exhibit favorable optical performance while achieving weight and size reduction.

Moreover, the zoom optical system ZL according to the present embodiment preferably satisfies Conditional Expressions (1) and (2) shown below.

$$1.45 < nd 1 < 1.63 \qquad ( 1 )$$

$$62.5 < vd 1 < 85. \qquad ( 2 )$$

in the expressions,
nd1: refractive index of a medium of the single lens L11 constituting the first lens group G1 at a d line, and
vd1: Abbe number of the medium of the single lens L11 constituting the first lens group G1 at the d line.

Conditional Expressions (1) and (2) define the refractive index and Abbe number of the medium of the one single lens L11 constituting the first lens group G1 at the d line. By disposing the single lens L11 that satisfies Conditional Expressions (1) and (2) in the first lens group G1, it is possible to achieve the zoom optical system ZL exhibiting favorable optical performance while achieving weight and size reduction. Meanwhile, it is possible to secure the advantageous effect of the present embodiment more surely by setting the upper limit value of Conditional Expression (1) to 1.62. Further, in order to secure the advantageous effect of the present embodiment further more surely, it is preferable to set the upper limit value of Conditional Expression (1) to 1.60. Meanwhile, it is possible to secure the advantageous effect of the present embodiment more surely by setting the lower limit value of Conditional Expression (1) to 1.46. Further, in order to secure the advantageous effect of the present embodiment further more surely, it is preferable to set the lower limit value of Conditional Expression (1) to 1.47. Moreover, it is possible to secure the advantageous effect of the present embodiment more surely by setting the upper limit value of Conditional Expression (2) to 82.56. Further, in order to secure the advantageous effect of the present embodiment further more surely, it is preferable to set the upper limit value of Conditional Expression (2) to 80.00. Meanwhile, it is possible to secure the advantageous effect of the present embodiment more surely by setting the lower limit value of Conditional Expression (2) to 64.00. Further, in order to secure the advantageous effect of the present embodiment further more surely, it is preferable to set the lower limit value of Conditional Expression (2) to 65.50.

Moreover, in the zoom optical system ZL according to the present embodiment, the final lens group GR preferably moves on the optical axis at zooming.

Moreover, the zoom optical system ZL according to the present embodiment preferably satisfies Conditional Expression (3) shown below.

$$4.8 < f 1 / ( - f 2 ) < 7 \text{.50} \qquad ( 3 )$$

in the expression,
f1: focal length of the first lens group G1, and
f2: focal length of the second lens group G2.

Conditional Expression (3) defines the ratio of the focal length of the first lens group G1 to the focal length of the second lens group G2. By satisfying Conditional Expression (3), it is possible to achieve the zoom optical system ZL exhibiting favorable optical performance while achieving weight and size reduction. When the upper limit value of Conditional Expression (3) is exceeded, the focal length of the second lens group G2 is short, and accordingly, spherical aberration, coma aberration, and field curvature that occur at the second lens group G2 are large and favorable optical performance cannot be obtained, and thus such a configuration is not preferable. Meanwhile, it is possible to secure the advantageous effect of the present embodiment more surely by setting the upper limit value of Conditional Expression (3) to 7.25. Further, in order to secure the advantageous effect of the present embodiment further more surely, it is preferable to set the upper limit value of Conditional Expression (3) to 7.00. Moreover, when the lower limit value of Conditional Expression (3) is exceeded, the focal length of the first lens group G1 is short, and accordingly, spherical aberration, coma aberration, and field curvature that occur at the first lens group G1 are large and favorable optical performance cannot be obtained, and thus such a configuration is not preferable. Meanwhile, it is possible to secure the advantageous effect of the present embodiment more surely by setting the lower limit value of Conditional Expression (3) to 5.00. Further, in order to secure the advantageous effect of the present embodiment further more surely, it is preferable to set the lower limit value of Conditional Expression (3) to 5.10.

Moreover, the zoom optical system ZL according to the present embodiment preferably satisfies Conditional Expression (4) shown below.

$$3.8 < f 1 / fMw < 6. \qquad ( 4 )$$

in the expression,
f1: focal length of the first lens group G1, and
fMw: focal length of the middle lens group GM in a wide-angle end state.

Conditional Expression (4) defines the ratio of the focal length of the first lens group G1 to the focal length of the middle lens group GM in the wide-angle end state. In a case where the middle lens group GM includes two lens groups, fMw is the combined focal length of the two lens groups in the wide-angle end state. By satisfying Conditional Expression (4), it is possible to achieve the zoom optical system ZL exhibiting favorable optical performance while achieving weight and size reduction. When the upper limit value of Conditional Expression (4) is exceeded, the focal length of the middle lens group GM is short, and accordingly, spherical aberration and coma aberration that occur at the middle lens group GM are large and favorable optical performance cannot be obtained, and thus such a configuration is not preferable. Meanwhile, it is possible to secure the advantageous effect of the present embodiment more surely by setting the upper limit value of Conditional Expression (4) to 5.80. Further, in order to secure the advantageous effect of the present embodiment further more surely, it is preferable to set the upper limit value of Conditional Expression (4) to 5.50. Moreover, when the lower limit value of Conditional Expression (4) is exceeded, the focal length of the first lens group G1 is short, and accordingly, spherical aberration, coma aberration, and field curvature that occur at the first lens group G1 are large and favorable optical performance cannot be obtained, and thus such a configuration is not preferable. Meanwhile, it is possible to secure the advantageous effect of the present embodiment more surely by setting the lower limit value of Conditional Expression (4) to 4.00. Further, in order to secure the advantageous effect of the present embodiment further more surely, it is preferable to set the lower limit value of Conditional Expression (4) to 4.30.

Moreover, the zoom optical system ZL according to the present embodiment preferably satisfies Conditional Expression (5) shown below.

$$2. < f 1 / ( - fF ) < 4. \qquad ( 5 )$$

in the expression,
f1: focal length of the first lens group G1, and
fF: focal length of the focusing lens group GF.

Conditional Expression (5) defines the ratio of the focal length of the first lens group G1 to the focal length of the focusing lens group GF. By satisfying Conditional Expression (5), it is possible to achieve the zoom optical system ZL exhibiting favorable optical performance while achieving weight and size reduction. When the upper limit value of Conditional Expression (5) is exceeded, the focal length of the focusing lens group GF is short, and accordingly, spherical aberration, coma aberration, and field curvature that occur at the focusing lens group GF are large and favorable optical performance cannot be obtained, and thus such a configuration is not preferable. Meanwhile, it is possible to secure the advantageous effect of the present embodiment more surely by setting the upper limit value of Conditional Expression (5) to 3.85. Further, in order to secure the advantageous effect of the present embodiment further more surely, it is preferable to set the upper limit value of Conditional Expression (5) to 3.70. Moreover, when the lower limit value of Conditional Expression (5) is exceeded, the focal length of the first lens group G1 is short, and accordingly, spherical aberration, coma aberration, and field curvature that occur at the first lens group G1 are large and favorable optical performance cannot be obtained, and thus such a configuration is not preferable. Meanwhile, it is possible to secure the advantageous effect of the present embodiment more surely by setting the lower limit value of Conditional Expression (5) to 2.25. Further, in order to secure the advantageous effect of the present embodiment further more surely, it is preferable to set the lower limit value of Conditional Expression (5) to 2.45.

Moreover, the zoom optical system ZL according to the present embodiment preferably satisfies Conditional Expression (6) shown below.

$$1.1 < f 1 / fR < 1 \text{.75} \qquad ( 6 )$$

in the expression,
f1: focal length of the first lens group G1, and
fR: focal length of the final lens group GR.

Conditional Expression (6) defines the ratio of the focal length of the first lens group G1 to the focal length of the final lens group GR. By satisfying Conditional Expression (6), it is possible to achieve the zoom optical system ZL exhibiting favorable optical performance while achieving weight and size reduction. When the upper limit value of Conditional Expression (6) is exceeded, the focal length of the final lens group GR is short, and accordingly, field curvature that occurs at the final lens group GR is large and favorable optical performance cannot be obtained, and thus such a configuration is not preferable. Meanwhile, it is possible to secure the advantageous effect of the present embodiment more surely by setting the upper limit value of Conditional Expression (6) to 1.65. Further, in order to secure the advantageous effect of the present embodiment further more surely, it is preferable to set the upper limit value of Conditional Expression (6) to 1.45. Moreover, when the lower limit value of Conditional Expression (6) is exceeded, the focal length of the first lens group G1 is short, and accordingly, spherical aberration, coma aberration, and field curvature that occur at the first lens group G1 are large and favorable optical performance cannot be obtained, and thus such a configuration is not preferable. Meanwhile, it is possible to secure the advantageous effect of the present embodiment more surely by setting the lower limit value of Conditional Expression (6) to 1.20. Further, in order to secure the advantageous effect of the present embodiment further more surely, it is preferable to set the lower limit value of Conditional Expression (6) to 1.35.

Moreover, the zoom optical system ZL according to the present embodiment preferably satisfies Conditional Expression (7) shown below.

$$0.4 < f 2 / fF < 0 \text{.65} \qquad ( 7 )$$

in the expression,
f2: focal length of the second lens group G2, and
fF: focal length of the focusing lens group GF.

Conditional Expression (7) defines the ratio of the focal length of the second lens group G2 to the focal length of the focusing lens group GF. By satisfying Conditional Expression (7), it is possible to achieve the zoom optical system ZL exhibiting favorable optical performance while achieving weight and size reduction. When the upper limit value of Conditional Expression (7) is exceeded, the focal length of the focusing lens group GF is short, and accordingly, spherical aberration, coma aberration, and field curvature that occur at the focusing lens group GF are large and favorable optical performance cannot be obtained, and thus such a configuration is not preferable. Meanwhile, it is possible to secure the advantageous effect of the present embodiment more surely by setting the upper limit value of Conditional Expression (7) to 0.60. Further, in order to secure the advantageous effect of the present embodiment further more surely, it is preferable to set the upper limit value of Conditional Expression (7) to 0.55. Moreover, when the lower limit value of Conditional Expression (7) is exceeded, the focal length of the second lens group G2 is short, and accordingly, spherical aberration, coma aberration, and field curvature that occur at the second lens group G2 are large and favorable optical performance cannot be obtained, and thus such a configuration is not preferable. Meanwhile, it is possible to secure the advantageous effect of the present embodiment more surely by setting the lower limit value of Conditional Expression (7) to 0.43. Further, in order to secure the advantageous effect of the present embodiment further more surely, it is preferable to set the lower limit value of Conditional Expression (7) to 0.45.

Moreover, the zoom optical system ZL according to the present embodiment preferably satisfies Conditional Expression (8) shown below.

$$0. 10 < ( - f 2 ) / fR < 0 \text{.35} \qquad ( 8 )$$

in the expression,
f2: focal length of the second lens group G2, and
fR: focal length of the final lens group GR.

Conditional Expression (8) defines the ratio of the focal length of the second lens group G2 to the focal length of the final lens group GR. By satisfying Conditional Expression (8), it is possible to achieve the zoom optical system ZL exhibiting favorable optical performance while achieving weight and size reduction. When the upper limit value of Conditional Expression (8) is exceeded, the focal length of the final lens group GR is short, and accordingly, field curvature that occurs at the final lens group GR is large and favorable optical performance cannot be obtained, and thus such a configuration is not preferable. Meanwhile, it is possible to secure the advantageous effect of the present embodiment more surely by setting the upper limit value of Conditional Expression (8) to 0.33. Further, in order to secure the advantageous effect of the present embodiment further more surely, it is preferable to set the upper limit value of Conditional Expression (8) to 0.30. Moreover, when the lower limit value of Conditional Expression (8) is exceeded, the focal length of the second lens group G2 is short, and accordingly, spherical aberration, coma aberration, and field curvature that occur at the second lens group G2 are large and favorable optical performance cannot be obtained, and thus such a configuration is not preferable. Meanwhile, it is possible to secure the advantageous effect of the present embodiment more surely by setting the lower limit value of Conditional Expression (8) to 0.15. Further, in order to secure the advantageous effect of the present embodiment further more surely, it is preferable to set the lower limit value of Conditional Expression (8) to 0.19.

Moreover, the zoom optical system ZL according to the present embodiment preferably satisfies Conditional Expression (9) shown below.

$$0.2 < fMw / fR < 0 \text{.40} \qquad ( 9 )$$

in the expression,
fMw: focal length of the middle lens group GM in the wide-angle end state, and
fR: focal length of the final lens group GR.

Conditional Expression (9) defines the ratio of the focal length of the middle lens group GM in the wide-angle end state to the focal length of the final lens group GR. In a case where the middle lens group GM includes two lens groups, fMw is the combined focal length of the two lens groups in the wide-angle end state. By satisfying Conditional Expression (9), it is possible to achieve the zoom optical system ZL exhibiting favorable optical performance while achieving weight and size reduction. When the upper limit value of Conditional Expression (9) is exceeded, the focal length of the final lens group GR is short, and accordingly, field curvature that occurs at the final lens group GR is large and favorable optical performance cannot be obtained, and thus such a configuration is not preferable. Meanwhile, it is possible to secure the advantageous effect of the present embodiment more surely by setting the upper limit value of Conditional Expression (9) to 0.37. Further, in order to secure the advantageous effect of the present embodiment further more surely, it is preferable to set the upper limit value of Conditional Expression (9) to 0.35. Moreover, when the lower limit value of Conditional Expression (9) is exceeded, the focal length of the middle lens group GM is short, and accordingly, spherical aberration and coma aberration that occur at the middle lens group GM are large and favorable optical performance cannot be obtained, and thus such a configuration is not preferable. Meanwhile, it is possible to secure the advantageous effect of the present embodiment more surely by setting the lower limit value of Conditional Expression (9) to 0.23. Further, in order to secure the advantageous effect of the present embodiment further more surely, it is preferable to set the lower limit value of Conditional Expression (9) to 0.25.

Moreover, the zoom optical system ZL according to the present embodiment preferably satisfies Conditional Expression (10) shown below.

$$0.2 < ( - fF ) / fR < 0 \text{.65} \qquad ( 10 )$$

in the expression,
fF: focal length of the focusing lens group GF, and
fR: focal length of the final lens group GR.

Conditional Expression (10) defines the ratio of the focal length of the focusing lens group GF to the focal length of the final lens group GR. By satisfying Conditional Expression (10), it is possible to achieve the zoom optical system ZL exhibiting favorable optical performance while achieving weight and size reduction. When the upper limit value of Conditional Expression (10) is exceeded, the focal length of the final lens group GR is short, and accordingly, field curvature that occurs at the final lens group GR is large and favorable optical performance cannot be obtained, and thus such a configuration is not preferable. Meanwhile, it is possible to secure the advantageous effect of the present embodiment more surely by setting the upper limit value of Conditional Expression (10) to 0.60. Further, in order to secure the advantageous effect of the present embodiment further more surely, it is preferable to set the upper limit value of Conditional Expression (10) to 0.58. Moreover, when the lower limit value of Conditional Expression (10) is exceeded, the focal length of the focusing lens group GF is short, and accordingly, spherical aberration, coma aberration, and field curvature that occur at the focusing lens group GF are large and favorable optical performance cannot be obtained, and thus such a configuration is not preferable. Meanwhile, it is possible to secure the advantageous effect of the present embodiment more surely by setting the lower limit value of Conditional Expression (10) to 0.25. Further, in order to secure the advantageous effect of the present embodiment further more surely, it is preferable to set the lower limit value of Conditional Expression (10) to 0.30.

Moreover, the zoom optical system ZL according to the present embodiment preferably satisfies Conditional Expression (11) shown below.

$$1. < fw / Bfw < 1.8 \qquad ( 11 )$$

in the expression,
fw: overall focal length of the zoom optical system ZL in the wide-angle end state, and
Bfw: back focus (air-conversion length) of the zoom optical system ZL in the wide-angle end state.

Conditional Expression (11) defines the ratio of the overall focal length to the back focus of the zoom optical system ZL in the wide-angle end state. By satisfying Conditional Expression (11), it is possible to achieve the zoom optical system ZL exhibiting favorable optical performance while achieving weight and size reduction. Meanwhile, it is possible to secure the advantageous effect of the present embodiment more surely by setting the upper limit value of Conditional Expression (11) to 1.70. Further, in order to secure the advantageous effect of the present embodiment further more surely, it is preferable to set the upper limit value of Conditional Expression (11) to 1.65. Meanwhile, it is possible to secure the advantageous effect of the present embodiment more surely by setting the lower limit value of Conditional Expression (11) to 1.10. Further, in order to secure the advantageous effect of the present embodiment further more surely, it is preferable to set the lower limit value of Conditional Expression (11) to 1.20.

Moreover, the zoom optical system ZL according to the present embodiment preferably satisfies Conditional Expression (12) shown below.

$$0.7 5 < f 1 / TLw < 1.35 \qquad ( 12 )$$

in the expression,
f1: focal length of the first lens group G1, and
TLw: optical total length (air-conversion length) of the zoom optical system ZL in the wide-angle end state.

Conditional Expression (12) defines the ratio of the focal length of the first lens group G1 to the optical total length of the zoom optical system ZL in the wide-angle end state. By satisfying Conditional Expression (12), it is possible to achieve the zoom optical system ZL exhibiting favorable optical performance while achieving weight and size reduction. Meanwhile, it is possible to secure the advantageous effect of the present embodiment more surely by setting the upper limit value of Conditional Expression (12) to 1.30. Further, in order to secure the advantageous effect of the present embodiment further more surely, it is preferable to set the upper limit value of Conditional Expression (12) to 1.20. Meanwhile, it is possible to secure the advantageous effect of the present embodiment more surely by setting the lower limit value of Conditional Expression (12) to 0.80. Further, in order to secure the advantageous effect of the present embodiment further more surely, it is preferable to set the lower limit value of Conditional Expression (12) to 0.90.

Moreover, the zoom optical system ZL according to the present embodiment preferably satisfies Conditional Expression (13) shown below.

$$0.7 < f 1 / TLt < 1. \qquad ( 13 )$$

in the expression,
f1: focal length of the first lens group G1, and
TLt: optical total length (air-conversion length) of the zoom optical system ZL in a telephoto end state.

Conditional Expression (13) defines the ratio of the focal length of the first lens group G1 to the optical total length of the zoom optical system ZL in the telephoto end state. By satisfying Conditional Expression (13), it is possible to achieve the zoom optical system ZL exhibiting favorable optical performance while achieving weight and size reduction. Meanwhile, it is possible to secure the advantageous effect of the present embodiment more surely by setting the upper limit value of Conditional Expression (13) to 0.95. Further, in order to secure the advantageous effect of the present embodiment further more surely, it is preferable to set the upper limit value of Conditional Expression (13) to 0.90. Meanwhile, it is possible to secure the advantageous effect of the present embodiment more surely by setting the lower limit value of Conditional Expression (13) to 0.73. Further, in order to secure the advantageous effect of the present embodiment further more surely, it is preferable to set the lower limit value of Conditional Expression (13) to 0.75.

Note that conditions and configurations described above each achieve an above-described effect, and not all configurations and conditions necessarily need to be satisfied but the above-described effect can be obtained with either conditions or configurations or with either combination of conditions or configurations.

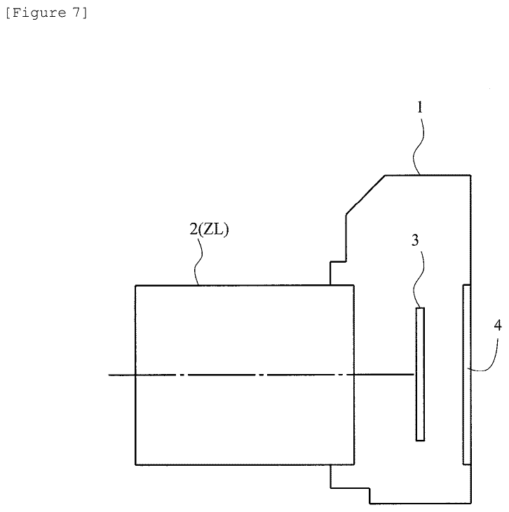

Subsequently, a camera that is an optical apparatus including the zoom optical system ZL according to the present embodiment will be described below with reference to FIG. 7. This camera 1 is what is called a mirrorless interchangeable lens camera including the zoom optical system ZL according to the present embodiment as an image pickup lens 2. In the camera 1, light from a non-shown object (subject) is condensed through the image pickup lens 2 and forms a subject image on the image surface of an image unit 3 through a non-shown optical low pass filter (OLPF). Then, the subject image is photoelectrically converted by a photoelectric conversion element provided in the image unit 3 and an image of the subject is generated. The image is displayed on an electronic view finder (EVF) 4 provided in the camera 1. Accordingly, a photographer can observe the subject through the EVF 4.

When a non-shown release button is pressed by the photographer, the image photoelectrically converted by the image unit 3 is stored in a non-shown memory. In this manner, the photographer can perform image capturing of the subject with the camera 1. Meanwhile, although the example of a mirrorless camera is described in the present embodiment, it is possible to achieve the same effects as those of the camera 1 described above when the zoom optical system ZL according to the present embodiment is mounted on a single-lens reflex camera that includes a quick return mirror in a camera body and with which a subject is observed through a finder optical system.

The contents described below are employable as appropriate to the extent that the optical performance is not compromised.

In the present embodiment, as described later, the zoom optical system ZL having a five-group configuration or a six-group configuration is shown, and such configurations, conditions, and the like are also applicable to any other group configuration such as a seven-group configuration or an eight-group configuration. Further, the zoom optical system ZL may instead have a configuration in which a lens or a lens group closest to the object side is added or a configuration in which a lens or a lens group closest to the image plane side is added. Specifically, such a configuration is a configuration in which a lens group having a position fixed relative to the image plane at zooming or focusing is added closest to the image plane side. A lens group means a part including at least one lens and separated by an air space that changes at zooming or focusing. A lens component means a single lens or a cemented lens obtained by cementing a plurality of lenses.

A focusing group may be a single lens group, a plurality of lens groups, or a partial lens group moved in the optical axis direction to focus on from an infinite distance object to a close distance object. In this case, the focusing group can also be used to perform autofocusing and is suitably driven by a motor for autofocusing (such as an ultrasonic wave motor). In particular, the focusing group is preferably a fourth lens group G4 (first example and second example) or a fifth lens group G5 (third example). Moreover, any lens other than the focusing group preferably has a fixed position relative to the image plane at focusing. The focusing group is preferably configured as a single lens or one lens component when a load on the motor is taken into consideration.

An anti-vibration group may be a lens group or a partial lens group so moved with a displacement component in the direction perpendicular to the optical axis or rotated (swung) in an in-plane direction containing the optical axis to correct an image blur caused by a camera shake. In particular, the anti-vibration group is preferably at least part of a third lens group G3 (first example and second example) or the fourth lens group G4 (third example).

A lens surface may be so formed as to be a spherical surface, a flat surface, or an aspheric surface. In the case where a lens surface is a spherical or flat surface, the lens is readily processed, assembled, and adjusted, whereby degradation in the optical performance due to errors in the lens processing, assembly, and adjustment is preferably avoided. Further, even when an image plane is shifted, the amount of degradation in drawing performance is preferably small. In the case where the lens surface is an aspheric surface, the aspheric surface may be any of a ground aspheric surface, a glass molded aspheric surface that is a glass surface so molded in a die as to have an aspheric shape, and a composite aspheric surface that is a glass surface on which aspherically shaped resin is formed. The lens surface may instead be a diffractive surface, or the lenses may be any of a distributed index lens (GRIN lens) or a plastic lens.

An aperture stop S is preferably disposed between the second lens group G2 and the third lens group G3. No member as an aperture stop may be provided, and the frame of a lens may serve as the aperture stop.

Further, each lens surface may be provided with an antireflection coating having high transmittance over a wide wavelength range to achieve good optical performance that reduces flare and ghost and achieves high contrast.

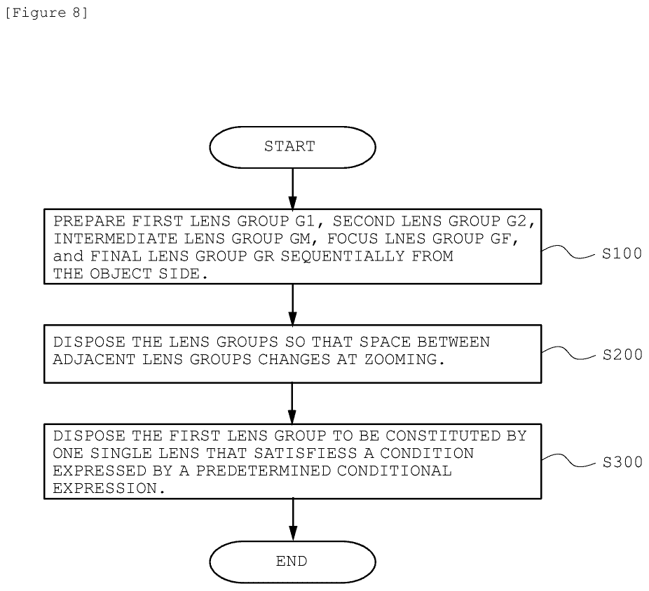

A method for manufacturing the zoom optical system ZL according to the present embodiment will be schematically described below with reference to FIG. 8. First, the first lens group G1 having positive refractive power, the second lens group G2 having negative refractive power, the middle lens group GM including one or two lens groups and having overall positive refractive power, the focusing lens group GF having negative refractive power and configured to move in an optical axis direction at focusing, and the final lens group GR having positive refractive power are prepared sequentially from an object side (step S100). Then, the lens groups are disposed so that the space between adjacent lens groups changes at zooming (step S200), and the first lens group G1 is disposed to be constituted by the one single lens L11 that satisfies a condition expressed by a predetermined conditional expression (for example, Conditional Expression (1) or (2) described above) (step S300).

With the above-described configuration, it is possible to provide a zoom optical system exhibiting favorable optical performance while achieving weight and size reduction, an optical apparatus, and a method for manufacturing the zoom optical system.

### EXAMPLES

Examples will be described below with reference to the drawings. Note that FIGS. 1, 3, and 5 are cross-sectional views showing the configurations and refractive power distribution of zoom optical systems ZL (ZL1 to ZL3) according to the examples. The lower part of each drawing shows the movement locus of each lens group of the zoom optical system ZL from the wide-angle end state (W) to the telephoto end state (T) at zooming.

In the examples, each aspheric surface is expressed by Expression (a) below, where y represents the height in a direction orthogonal to the optical axis, S (y) represents the distance (sag amount) on the optical axis from a tangent plane at the apex of the aspheric surface at the height y to the aspheric surface, r represents the radius of curvature (paraxial radius of curvature) of a reference spherical surface, K represents the conic constant, and An represents the n-th aspheric surface coefficient. Note that, in the examples below, “E-n” represents “×10⁻ⁿ”.

$$S ( y ) = ( {y}^{2} / r ) / \{ 1 + {( 1 - K \times {y}^{2} / {r}^{2} )}^{1 / 2} \} + A 4 \times {y}^{4} + A 6 \times {y}^{6} + A 8 \times {y}^{8} + A 10 \times {y}^{10} + A 12 \times {y}^{12} \qquad ( a )$$

Note that, in the examples, the second aspheric surface coefficient A2 is zero.

The examples described below show specific examples of the present application invention, and the present application invention is not limited to the examples.

### First Example

FIG. 1 is a diagram showing the configuration of a zoom optical system ZL1 according to a first example. The zoom optical system ZL1 includes, sequentially from an object side, a first lens group G1 having positive refractive power, a second lens group G2 having negative refractive power, a third lens group G3 having positive refractive power, a focusing lens group GF that is a fourth lens group G4 having negative refractive power and configured to move in an optical axis direction at focusing, and a final lens group GR that is a fifth lens group G5 having positive refractive power. In the zoom optical system ZL1, the third lens group G3 corresponds to a middle lens group GM.

The first lens group G1 is constituted by, as one single lens, a positive meniscus lens L11 having a convex surface facing the object side. The second lens group G2 includes, sequentially from the object side, a negative meniscus lens L21 having a convex surface facing the object side, a negative biconcave lens L22, a positive biconvex lens L23, and a negative meniscus lens L24 having a concave surface facing the object side. The third lens group G3 includes, sequentially from the object side, a positive biconvex lens L31, a negative meniscus lens L32 having a convex surface facing the object side, a negative cemented lens formed by cementing a negative biconcave lens L33 and a positive biconvex lens L34, and a positive biconvex lens L35. The fourth lens group G4 includes a negative meniscus lens L41 having a convex surface facing the object side. The fifth lens group G5 includes, sequentially from the object side, a negative meniscus lens L51 having a concave surface facing the object side, and a positive biconvex lens L52. Note that the negative lens L21 is a composite lens in which a resin layer is provided on the object-side lens surface of a glass lens body to form an aspheric surface. The positive lens L31 is formed with an aspheric lens surface on the object side and an aspheric lens surface on the image plane side. An aperture stop S is disposed between the second lens group G2 and the third lens group G3.

In the zoom optical system ZL1, at zooming, the first lens group G1, the second lens group G2, the third lens group G3, the fourth lens group G4, and the fifth lens group G5 (final lens group GR) move on the optical axis so that the spaces between the lens groups change. Note that the aperture stop S moves together with the third lens group G3.

Moreover, in the zoom optical system ZL1, image position correction (anti-vibration) when a camera shake occurs is performed by moving the positive lens L35 of the third lens group G3 with a displacement component in a direction perpendicular to the optical axis.

Moreover, in the zoom optical system ZL1, focusing on from an infinite distance object to a close distance object is performed by moving the fourth lens group G4 as the focusing lens group GF on the optical axis to an image side.

Table 1 below shows values of specifications of the zoom optical system ZL1. In Table 1, the following specifications shown as overall specifications are defined as follows: f represents the overall focal length; Fno represents the F number; ω represents the half angle of view (maximum incident angle in the unit of [°]); Y represents the maximum image height; TL represents the optical total length; and Bf represents values of the back focus at focusing on an infinite distance object in the wide-angle end state, an intermediate focal length state, and the telephoto end state. The back focus Bf represents the air-conversion length of the distance on the optical axis from the lens surface (twenty-seventh surface) closest to the image plane side to an image plane I. The optical total length TL represents a summed length of the distance on the optical axis from the lens surface (first surface) closest to the object side to the lens surface (twenty-seventh surface) closest to the image plane side and the air-conversion length of the back focus. In lens data, a first field m shows the sequence of lens surfaces (surface numbers) counted from the object side in a direction in which a ray travels. A second field r shows the radius of curvature of each lens surface. A third field d shows the distance (inter-surface distance) on the optical axis from each optical surface to the next optical surface. A fourth field nd and a fifth field vd show the refractive index and the Abbe number at the d line (λ=587.6 nm). A radius of curvature of ∞ represents a flat surface, and the refractive index of air, which is 1.00000, is omitted. The symbol * is provided on the right side of the surface number when a lens surface is an aspheric surface, and the field of the radius of curvature r shows the paraxial radius of curvature. The lens group focal length shows the number of the first surface and the focal length of each of the first to fifth lens groups G1 to G5.

The unit of each of the focal length f, the radius of curvature r, the inter-surface distance d, and other lengths shown in all the variety of specifications below is typically “mm”, but not limited to this, because an optical system provides the same optical performance even when the optical system is proportionally enlarged or reduced.

Note that the description of the reference characters and the description of specification tables apply to subsequent examples as well.

TABLE 1
First example
[Overall specifications]

| | Wide- | Intermediate | Telephoto |
|---|---|---|---|
| | angle end | focal length | end |
| f | 16.480 | 35.000 | 48.500 |
| Fno | 2.912 | 2.912 | 2.912 |
| ω | 42.697 | 21.877 | 16.021 |
| Y | 13.703 | 14.200 | 14.200 |
| TL(air-conversion length) | 100.155 | 107.321 | 126.930 |
| Bf(air-conversion length) | 10.852 | 15.002 | 20.124 |

[Lens data]

| m | r | d | nd | vd | |
|---|---|---|---|---|---|
| Object plane | ∞ | | | | |
| 1 | 46.5018 | 7.272 | 1.48749 | 70.32 | |
| 2 | 408.3816 | D2 | | | |
| 3* | 136.5101 | 0.050 | 1.56093 | 36.64 | |
| 4 | 66.8522 | 1.300 | 1.83481 | 42.73 | |
| 5 | 14.6653 | 7.584 | | | |
| 6 | −45.3757 | 1.000 | 1.79500 | 45.31 | |
| 7 | 61.3801 | 0.529 | | | |
| 8 | 34.9234 | 3.918 | 1.84666 | 23.80 | |
| 9 | −49.9980 | 1.473 | | | |
| 10 | −20.2084 | 1.226 | 1.83400 | 37.18 | |
| 11 | −33.8168 | D11 | | | |
| 12 | ∞ | 1.500 | | | Aperture stop S |
| 13* | 20.1310 | 5.426 | 1.85108 | 40.12 | |
| 14* | −47.1968 | 0.966 | | | |
| 15 | 41.3577 | 3.151 | 1.79504 | 28.69 | |
| 16 | 18.7104 | 2.515 | | | |
| 17 | −47.4062 | 0.900 | 1.80518 | 25.45 | |
| 18 | 15.4271 | 6.106 | 1.49782 | 82.57 | |
| 19 | −17.9780 | 1.429 | | | |
| 20 | 33.5686 | 2.364 | 1.80400 | 46.60 | |
| 21 | −826.3821 | D21 | | | |
| 22 | 106.6457 | 1.060 | 1.85026 | 32.35 | |
| 23 | 25.1644 | D23 | | | |
| 24 | −33.1197 | 1.000 | 1.75500 | 52.34 | |
| 25 | −85.8550 | 0.100 | | | |
| 26 | 74.7201 | 4.479 | 1.86966 | 20.02 | |
| 27 | −58.0572 | Bf | | | |
| Image plane | ∞ | | | | |

[Focal length of lens groups]

| Lens group | First surface | Focal length |
|---|---|---|
| First lens group G1 | 1 | 106.944 |
| Second lens group G2 | 3 | −18.564 |
| Third lens group G3 | 12 | 21.446 |
| Fourth lens group G4 | 22 | −38.969 |
| Fifth lens group G5 | 24 | 75.827 |

In the zoom optical system ZL1, the third surface, the thirteenth surface, and the fourteenth surface are aspheric surfaces. Table 2 below shows aspheric surface data, in other words, the values of the conic constant K and the aspheric surface constants A4 to A12 for the surface number.

TABLE 2
[Aspheric surface data]
Third surface

| | | |
|---|---|---|
| K = 1.00000 | | |
| A4 = 1.59272E−05 | A6 = −3.39148E−08 | A8 = 1.14126E−10 |
| A10 = −5.80834E−14 | A12 = 0.00000E−00 | |

Thirteenth surface

| | | |
|---|---|---|
| K = 1.00000 | | |
| A4 = −1.62725E−05 | A6 = −9.04684E−09 | A8 = 5.95302E−11 |
| A10 = −1.31075E−12 | A12 = 0.00000E−00 | |

Fourteenth surface

| | | |
|---|---|---|
| K = 1.00000 | | |
| A4 = 2.50810E−05 | A6 = −4.76238E−08 | A8 = 6.96628E−11 |
| A10 = −8.53155E−13 | A12 = 0.00000E−00 | |

In the zoom optical system ZL1, an on-axis air space D2 between the first lens group G1 and the second lens group G2, an on-axis air space D11 between the second lens group G2 and the third lens group G3, an on-axis air space D21 between the third lens group G3 and the fourth lens group G4, an on-axis air space D23 between the fourth lens group G4 and the fifth lens group G5, and the back focus Bf change at zooming and focusing. Table 3 below shows variable spaces in the wide-angle end state, the intermediate focal length state, and the telephoto end state at focusing on an infinite distance object and at focusing on a close distance object. Note that, in Table 3, f represents the overall focal length, β represents the magnification, and DO represents the distance on the optical axis from the lens surface (first surface) closest to the object side to the object. The description of the reference characters applies to subsequent examples as well.

TABLE 3
[Variable space data]

| | At focusing on infinite distance object | | | At focusing on close distance object | | |
|---|---|---|---|---|---|---|
| | Wide-angle | | Telephoto | Wide-angle | | Telephoto |
| | end | Intermediate | end | end | Intermediate | end |
| f | 16.480 | 35.000 | 48.500 | — | — | — |
| β | — | — | — | −0.221 | −0.221 | −0.245 |
| D0 | ∞ | ∞ | ∞ | 49.845 | 112.679 | 123.070 |
| D2 | 1.150 | 15.983 | 29.891 | 1.150 | 15.983 | 29.891 |
| D11 | 21.701 | 3.424 | 2.000 | 21.701 | 3.424 | 2.000 |
| D21 | 2.122 | 5.358 | 2.000 | 5.338 | 10.686 | 8.015 |
| D23 | 8.982 | 12.206 | 17.567 | 5.766 | 6.877 | 11.552 |
| Bf | 10.852 | 15.002 | 20.124 | 10.852 | 15.002 | 20.124 |

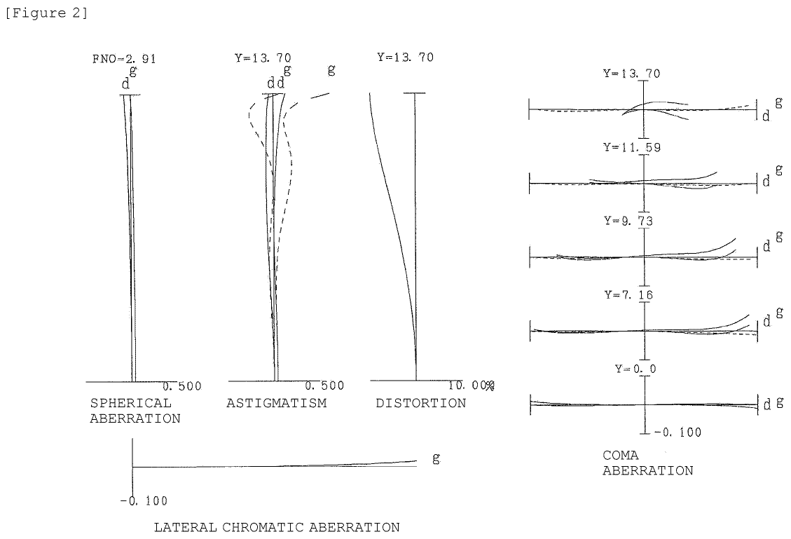

FIG. 2 shows a spherical aberration diagram, an astigmatism diagram, a distortion diagram, a lateral chromatic aberration diagram, and a coma aberration diagram of the zoom optical system ZL1 at focusing on an infinite distance object in the wide-angle end state. In each aberration diagram, FNO represents the F number and Y represents the image height. Note that the spherical aberration diagram shows the value of the F number corresponding to the maximum diameter, the astigmatism diagram and the distortion diagram show the value of the image height, and the coma aberration diagram shows the value of each image height. In addition, in the spherical aberration diagram and the coma aberration diagram, reference character d represents the d-line (λ=587.6 nm), and reference character g represents the g-line (λ=435.8 nm). In the astigmatism diagram, the solid line represents the sagittal image plane, and the dashed line represents the meridional image plane. In the coma aberration diagram, the solid line represents the meridional image plane, and the dashed line represents the sagittal image plane. Further, in the aberration diagrams in the following examples, the same reference characters as those in the present example are used. The aberration diagrams show that the zoom optical system ZL1 allows favorable correction of the variety of aberrations and has excellent imaging performance.

### Second Example

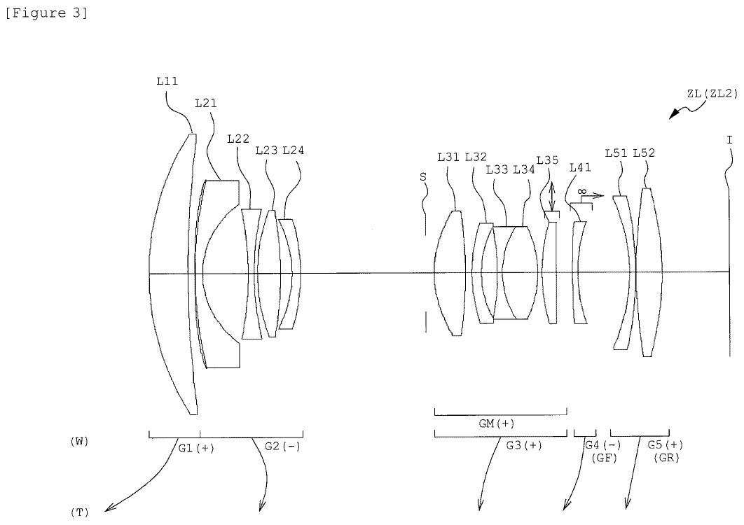

FIG. 3 is a diagram showing the configuration of a zoom optical system ZL2 according to a second example. The zoom optical system ZL2 includes, sequentially from an object side, a first lens group G1 having positive refractive power, a second lens group G2 having negative refractive power, a third lens group G3 having positive refractive power, a focusing lens group GF that is a fourth lens group G4 having negative refractive power and configured to move in an optical axis direction at focusing, and a final lens group GR that is a fifth lens group G5 having positive refractive power. In the zoom optical system ZL2, the third lens group G3 corresponds to a middle lens group GM.

The first lens group G1 is constituted by, as one single lens, a positive meniscus lens L11 having a convex surface facing the object side. The second lens group G2 includes, sequentially from the object side, a negative meniscus lens L21 having a convex surface facing the object side, a negative biconcave lens L22, a positive biconvex lens L23, and a negative meniscus lens L24 having a concave surface facing the object side. The third lens group G3 includes, sequentially from the object side, a positive biconvex lens L31, a negative meniscus lens L32 having a convex surface facing the object side, a negative cemented lens formed by cementing a negative biconcave lens L33 and a positive biconvex lens L34, and a positive biconvex lens L35. The fourth lens group G4 includes a negative meniscus lens L41 having a convex surface facing the object side. The fifth lens group G5 includes, sequentially from the object side, a negative meniscus lens L51 having a concave surface facing the object side, and a positive biconvex lens L52. Note that the negative lens L21 is a composite lens in which a resin layer is provided on the object-side lens surface of a glass lens body to form an aspheric surface. The positive lens L31 is formed with an aspheric lens surface on the object side and an aspheric lens surface on the image plane side. An aperture stop S is disposed between the second lens group G2 and the third lens group G3.

In the zoom optical system ZL2, at zooming, the first lens group G1, the second lens group G2, the third lens group G3, the fourth lens group G4, and the fifth lens group G5 (final lens group GR) move on the optical axis so that the spaces between the lens groups change. Note that the aperture stop S moves together with the third lens group G3.

Moreover, in the zoom optical system ZL2, image position correction (anti-vibration) when a camera shake occurs is performed by moving the positive lens L35 of the third lens group G3 with a displacement component in a direction perpendicular to the optical axis.

Moreover, in the zoom optical system ZL2, focusing on from an infinite distance object to a close distance object is performed by moving the fourth lens group G4 as the focusing lens group GF on the optical axis to an image side.

Table 4 below shows values of specifications of the zoom optical system ZL2. Note that, in Table 4, the lens group focal length shows the number of the first surface and the focal length of each of the first to fifth lens groups G1 to G5.

TABLE 4
Second example
[Overall specifications]

| | Wide-angle | Intermediate | Telephoto |
|---|---|---|---|
| | end | focal length | end |
| f | 16.480 | 35.000 | 48.500 |
| Fno | 2.912 | 2.912 | 2.912 |
| ω | 42.664 | 22.015 | 16.180 |
| Y | 13.703 | 14.200 | 14.200 |
| TL(air-conversion length) | 100.155 | 107.705 | 125.373 |
| Bf(air-conversion length) | 11.697 | 16.622 | 21.303 |

[Lens data]

| m | r | d | nd | vd | |
|---|---|---|---|---|---|
| Object plane | ∞ | | | | |
| 1 | 44.5814 | 6.848 | 1.59349 | 67.00 | |
| 2 | 185.5658 | D2 | | | |
| 3* | 153.8319 | 0.050 | 1.56093 | 36.64 | |
| 4 | 69.6014 | 1.300 | 1.83481 | 42.73 | |
| 5 | 14.6513 | 7.801 | | | |
| 6 | −55.6723 | 1.000 | 1.80440 | 39.61 | |
| 7 | 49.5009 | 0.593 | | | |
| 8 | 32.5138 | 3.921 | 1.84666 | 23.80 | |
| 9 | −64.9436 | 2.054 | | | |
| 10 | −19.6826 | 1.500 | 1.75500 | 52.34 | |
| 11 | −31.2494 | D11 | | | |
| 12 | ∞ | 1.500 | | | Aperture stop S |
| 13* | 18.6861 | 5.444 | 1.85108 | 40.12 | |
| 14* | −52.9303 | 1.074 | | | |
| 15 | 29.4394 | 1.619 | 1.85026 | 32.35 | |
| 16 | 16.4311 | 2.797 | | | |
| 17 | −41.0732 | 0.900 | 1.80518 | 25.45 | |
| 18 | 15.2459 | 6.073 | 1.49782 | 82.57 | |
| 19 | −17.7821 | 0.697 | | | |
| 20 | 31.7706 | 2.403 | 1.78800 | 47.35 | |
| 21 | −4370.0352 | D21 | | | |
| 22 | 153.8425 | 0.900 | 1.85026 | 32.35 | |
| 23 | 26.4287 | D23 | | | |
| 24 | −30.6834 | 1.000 | 1.75500 | 52.34 | |
| 25 | −60.5124 | 0.100 | | | |
| 26 | 90.3717 | 4.499 | 1.86966 | 20.02 | |
| 27 | −52.7177 | Bf | | | |
| Image plane | ∞ | | | | |

[Focal length of lens groups]

| Lens group | First surface | Focal length |
|---|---|---|
| First lens group G1 | 1 | 97.114 |
| Second lens group G2 | 3 | −18.342 |
| Third lens group G3 | 12 | 21.211 |
| Fourth lens group G4 | 22 | −37.653 |
| Fifth lens group G5 | 24 | 68.262 |

In the zoom optical system ZL2, the third surface, the thirteenth surface, and the fourteenth surface are aspheric surfaces. Table 5 below shows aspheric surface data, in other words, the values of the conic constant K and the aspheric surface constants A4 to A12 for the surface number.

TABLE 5
[Aspheric surface data]
Third surface

| | | |
|---|---|---|
| K = 1.0000 | | |
| A4 = 1.68417E−05 | A6 = −3.56538E−08 | A8 = 1.08569E−10 |
| A10 = −7.12771E−14 | A12 = 0.00000E−00 | |

Thirteenth surface

| | | |
|---|---|---|
| K = 1.0000 | | |
| A4 = −1.80545E−05 | A6 = −1.77998E−08 | A8 = 8.38042E−11 |
| A10 = −8.62163E−13 | A12 = 0.00000E−00 | |

Fourteenth surface

| | | |
|---|---|---|
| K = 1.0000 | | |
| A4 = 2.57593E−05 | A6 = −5.94339E−08 | A8 = 2.20073E−10 |
| A10 = −8.59413E−13 | A12 = 0.00000E−00 | |

In the zoom optical system ZL2, an on-axis air space D2 between the first lens group G1 and the second lens group G2, an on-axis air space D11 between the second lens group G2 and the third lens group G3, an on-axis air space D21 between the third lens group G3 and the fourth lens group G4, an on-axis air space D23 between the fourth lens group G4 and the fifth lens group G5, and the back focus Bf change at zooming and focusing. Table 6 below shows variable spaces in the wide-angle end state, the intermediate focal length state, and the telephoto end state at focusing on an infinite distance object and at focusing on a close distance object.

TABLE 6
[Variable space data]

| | At focusing on infinite distance object | | | At focusing on close distance object | | |
|---|---|---|---|---|---|---|
| | Wide-angle | | Telephoto | Wide-angle | | Telephoto |
| | end | Intermediate | end | end | Intermediate | end |
| f | 16.480 | 35.000 | 48.500 | — | — | — |
| β | — | — | — | −0.222 | −0.219 | −0.244 |
| D0 | ∞ | ∞ | ∞ | 49.845 | 112.295 | 124.627 |
| D2 | 1.150 | 16.385 | 28.332 | 1.150 | 16.385 | 28.332 |
| D11 | 21.464 | 3.601 | 2.000 | 21.464 | 3.601 | 2.000 |
| D21 | 2.862 | 5.191 | 2.000 | 5.915 | 10.214 | 7.803 |
| D23 | 8.909 | 11.832 | 17.664 | 5.856 | 6.809 | 11.861 |
| Bf | 11.697 | 16.622 | 21.303 | 11.697 | 16.622 | 21.303 |

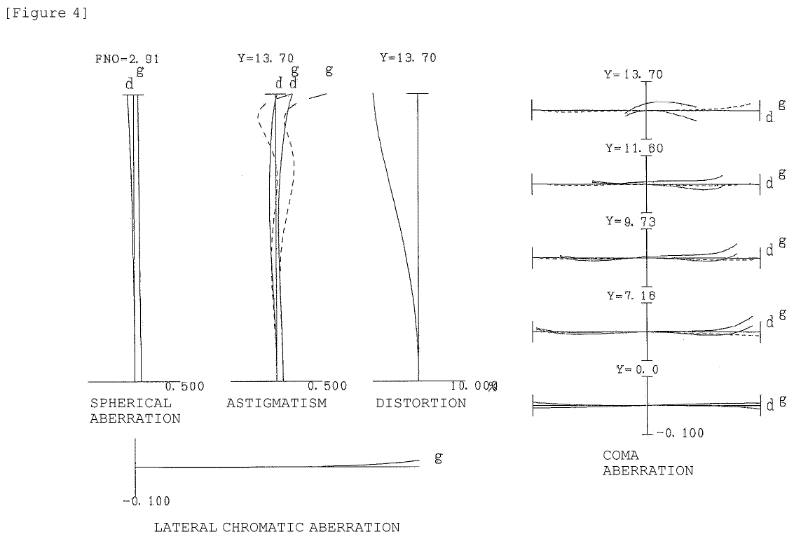

FIG. 4 shows a spherical aberration diagram, an astigmatism diagram, a distortion diagram, a lateral chromatic aberration diagram, and a coma aberration diagram of the zoom optical system ZL2 at focusing on an infinite distance object in the wide-angle end state. The aberration diagrams show that the zoom optical system ZL2 allows favorable correction of the variety of aberrations and has excellent imaging performance.

### Third Example

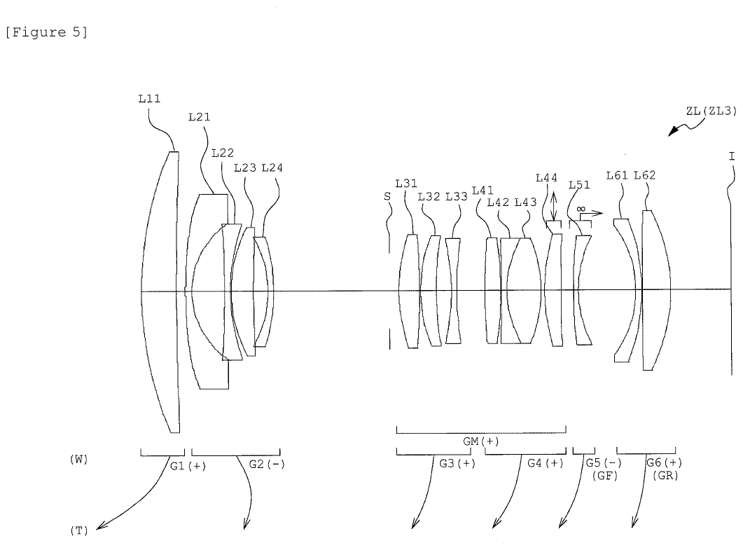

FIG. 5 is a diagram showing the configuration of a zoom optical system ZL3 according to a third example. The zoom optical system ZL3 includes, sequentially from an object side, a first lens group G1 having positive refractive power, a second lens group G2 having negative refractive power, a third lens group G3 having positive refractive power, a fourth lens group G4 having positive refractive power, a focusing lens group GF that is a fifth lens group G5 having negative refractive power and configured to move in an optical axis direction at focusing, and a final lens group GR that is a sixth lens group G6 having positive refractive power. In the zoom optical system ZL3, two lens groups of the third lens group G3 and the fourth lens group G4 correspond to a middle lens group GM. The combined focal length of the third lens group G3 and the fourth lens group G4 has positive refractive power over the entire focal length from the wide-angle end state to the telephoto end state.

The first lens group G1 is constituted by, as one single lens, a positive meniscus lens L11 having a convex surface facing the object side. The second lens group G2 includes, sequentially from the object side, a negative meniscus lens L21 having a convex surface facing the object side, a negative biconcave lens L22, a positive meniscus lens L23 having a convex surface facing the object side, and a negative meniscus lens L24 having a concave surface facing the object side. The third lens group G3 includes, sequentially from the object side, a positive biconvex lens L31, a positive meniscus lens L32 having a convex surface facing the object side, and a negative biconcave lens L33. The fourth lens group G4 includes, sequentially from the object side, a positive biconvex lens L41, a positive cemented lens formed by cementing a negative biconcave lens L42 and a positive biconvex lens L43, and a positive meniscus lens L44 having a convex surface facing the object side. The fifth lens group G5 includes a negative meniscus lens L51 having a convex surface facing the object side. The sixth lens group G6 includes, sequentially from the object side, a negative meniscus lens L61 having a concave surface facing the object side, and a positive biconvex lens L62. Note that the negative lens L21 is formed with an aspheric lens surface on the object side, and the positive lens L41 is formed with an aspheric lens surface on the object side. An aperture stop S is disposed between the second lens group G2 and the third lens group G3.

In the zoom optical system ZL3, at zooming, the first lens group G1, the second lens group G2, the third lens group G3, the fourth lens group G4, the fifth lens group G5, and the sixth lens group G6 (final lens group GR) move on the optical axis so that the spaces between the lens groups change. Note that the aperture stop S moves together with the third lens group G3.

Moreover, in the zoom optical system ZL3, image position correction (anti-vibration) when a camera shake occurs is performed by moving the positive lens L44 of the fourth lens group G4 with a displacement component in a direction perpendicular to the optical axis.

Moreover, in the zoom optical system ZL3, focusing on from an infinite distance object to a close distance object is performed by moving the fifth lens group G5 as the focusing lens group GF on the optical axis to an image side.

Table 7 below shows values of specifications of the zoom optical system ZL3. Note that, in Table 7, the lens group focal length shows the number of the first surface and the focal length of each of the first to sixth lens groups G1 to G6.

TABLE 7
Third example
[Overall specifications]

| | Wide- | Intermediate | Telephoto |
|---|---|---|---|
| | angle end | focal length | end |
| f | 16.482 | 28.000 | 48.459 |
| Fno | 2.880 | 2.880 | 2.880 |
| ω | 42.653 | 26.682 | 15.902 |
| Y | 13.885 | 14.200 | 14.200 |
| TL(air-conversion length) | 100.014 | 106.921 | 128.169 |
| Bf(air-conversion length) | 10.302 | 16.621 | 27.268 |

[Lens data]

| m | r | d | nd | vd | |
|---|---|---|---|---|---|
| Object plane | ∞ | | | | |
| 1 | 61.0909 | 5.996 | 1.59349 | 67.00 | |
| 2 | 686.9805 | D2 | | | |
| 3* | 85.9734 | 1.100 | 1.71300 | 53.96 | |
| 4 | 14.0683 | 5.455 | | | |
| 5 | −178.7274 | 1.000 | 1.71300 | 53.96 | |
| 6 | 33.5456 | 0.150 | | | |
| 7 | 23.8666 | 3.751 | 1.80518 | 25.45 | |
| 8 | 172.4103 | 2.499 | | | |
| 9 | −18.6039 | 1.000 | 1.83481 | 42.73 | |
| 10 | −30.4955 | D10 | | | |
| 11 | ∞ | 1.500 | | | Aperture stop S |
| 12 | 30.3961 | 3.509 | 1.84850 | 43.79 | |
| 13 | −99.0853 | 0.150 | | | |
| 14 | 25.9460 | 2.573 | 1.49782 | 82.57 | |
| 15 | 52.3273 | 2.620 | | | |
| 16 | −38.1600 | 0.900 | 1.64769 | 33.72 | |
| 17 | 62.0567 | D17 | | | |
| 18* | 58.5455 | 2.763 | 1.59349 | 67.00 | |
| 19 | −59.2707 | 0.150 | | | |
| 20 | −207.7349 | 0.900 | 1.64769 | 33.72 | |
| 21 | 18.0774 | 5.697 | 1.49782 | 82.57 | |
| 22 | −23.2115 | 0.642 | | | |
| 23 | 35.1108 | 2.828 | 1.81600 | 46.59 | |
| 24 | 717.6419 | D24 | | | |
| 25 | 74.7293 | 0.900 | 1.85026 | 32.35 | |
| 26 | 19.5842 | D26 | | | |
| 27 | −18.4123 | 1.000 | 1.83481 | 42.73 | |
| 28 | −33.2771 | 0.100 | | | |
| 29 | 958.0302 | 4.829 | 1.84666 | 23.80 | |
| 30 | −29.1663 | Bf | | | |
| Image plane | ∞ | | | | |

[Focal length of lens groups]

| Lens group | First surface | Focal length |
|---|---|---|
| First lens group G1 | 1 | 112.581 |
| Second lens group G2 | 3 | −16.515 |
| Third lens group G3 | 11 | 38.095 |
| Fourth lens group G4 | 18 | 20.269 |
| Fifth lens group G5 | 25 | −31.449 |
| Sixth lens group G6 | 27 | 80.009 |

In the zoom optical system ZL3, the third surface and the eighteenth surface are aspheric surfaces. Table 8 below shows aspheric surface data, in other words, the values of the conic constant K and the aspheric surface constants A4 to A12 for the surface number.

TABLE 8
[Aspheric surface data]
Third surface

| | | |
|---|---|---|
| K = 1.00000 | | |
| A4 = 9.25982E−06 | A6 = −6.14077E−09 | A8 = 7.75003E−11 |
| A10 = −3.97760E−13 | A12 = 1.20510E−15 | |

Eighteenth surface

| | | |
|---|---|---|
| K = 1.00000 | | |
| A4 = −4.40876E−05 | A6 = 4.98433E−08 | A8 = −4.06429E−10 |
| A10 = 5.67993E−12 | A12 = −2.68170E−14 | |

In the zoom optical system ZL3, an on-axis air space D2 between the first lens group G1 and the second lens group G2, an on-axis air space D10 between the second lens group G2 and the third lens group G3, an on-axis air space D17 between the third lens group G3 and the fourth lens group G4, an on-axis air space D24 between the fourth lens group G4 and the fifth lens group G5, an on-axis air space D26 between the fifth lens group G5 and the sixth lens group G6, and the back focus Bf change at zooming and focusing. Table 9 below shows variable spaces in the wide-angle end state, the intermediate focal length state, and the telephoto end state at focusing on an infinite distance object and at focusing on a close distance object.

TABLE 9
[Variable space data]

| | At focusing on infinite distance object | | | At focusing on close distance object | | |
|---|---|---|---|---|---|---|
| | Wide-angle | | Telephoto | Wide-angle | | Telephoto |
| | end | Intermediate | end | end | Intermediate | end |
| f | 16.482 | 28.000 | 48.459 | — | — | — |
| β | — | — | — | −0.220 | −0.224 | −0.249 |
| D0 | ∞ | ∞ | ∞ | 49.986 | 83.079 | 121.831 |
| D2 | 1.490 | 13.884 | 30.784 | 1.490 | 13.884 | 30.784 |
| D10 | 19.755 | 7.956 | 1.644 | 19.755 | 7.956 | 1.644 |
| D17 | 4.727 | 2.512 | 1.493 | 4.727 | 2.512 | 1.493 |
| D24 | 1.992 | 2.828 | 1.997 | 4.191 | 5.757 | 6.123 |
| D26 | 9.734 | 11.105 | 12.969 | 7.535 | 8.177 | 8.843 |
| Bf | 10.302 | 16.621 | 27.268 | 10.302 | 16.621 | 27.268 |

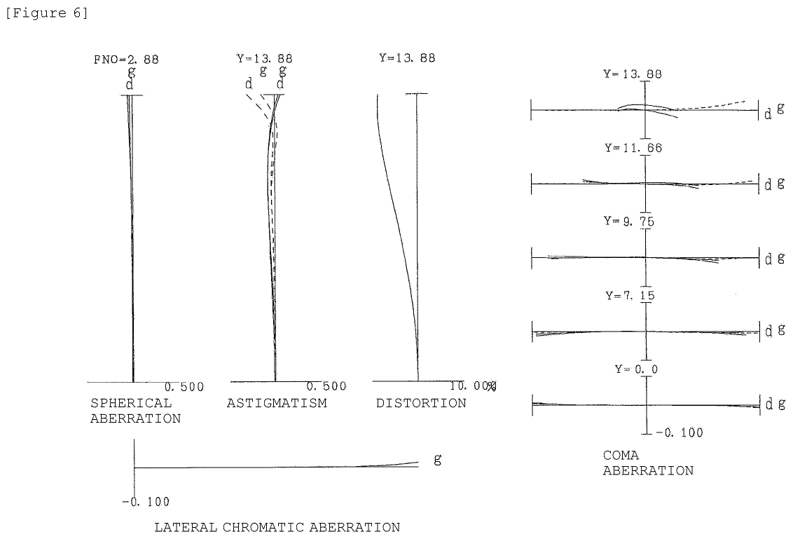

FIG. 6 shows a spherical aberration diagram, an astigmatism diagram, a distortion diagram, a lateral chromatic aberration diagram, and a coma aberration diagram of the zoom optical system ZL3 at focusing on an infinite distance object in the wide-angle end state. The aberration diagrams show that the zoom optical system ZL3 allows favorable correction of the variety of aberrations and has excellent imaging performance.

### [Conditional Expression Correspondence Value]

Table 10 below shows correspondence values of Conditional Expressions (1) to (13) in the first to third examples. Note that, in Table 10, the focal length fMw of the middle lens group GM in the wide-angle end state is the focal length of the third lens group G3 in the first and second examples, or is the combined focal length of the third lens group G3 and the fourth lens group G4 in the wide-angle end state in the third example.

TABLE 10

| | First | Second | Third |
|---|---|---|---|
| | example | example | example |
| fMw | 21.446 | 21.211 | 20.866 |
| (1)nd1 | 1.487 | 1.593 | 1.593 |
| (2)vd1 | 70.32 | 67.00 | 67.00 |
| (3)f1/(−f2) | 5.761 | 5.295 | 6.817 |
| (4)f1/fMw | 4.987 | 4.578 | 5.395 |
| (5)f1/(−fF) | 2.744 | 2.579 | 3.580 |
| (6)f1/fR | 1.410 | 1.423 | 1.407 |
| (7)f2/fF | 0.476 | 0.487 | 0.525 |
| (8)(−f2)/fR | 0.245 | 0.269 | 0.206 |
| (9)fMw/fR | 0.283 | 0.311 | 0.261 |
| (10)(−fF)/fR | 0.514 | 0.552 | 0.393 |
| (11)fw/Bfw | 1.519 | 1.409 | 1.600 |
| (12)f1/TLw | 1.068 | 0.970 | 1.126 |
| (13)f1/TLt | 0.843 | 0.775 | 0.878 |

### REFERENCE SIGNS LIST

1 camera (optical apparatus)
ZL (ZL1 to ZL3) zoom optical system
G1 first lens group
G2 second lens group
GM middle lens group
GF focusing lens group
GR final lens group

1. A zoom optical system comprising, sequentially from an object side:
a first lens group having positive refractive power;
a second lens group having negative refractive power;
a middle lens group including one or two lens groups and having overall positive refractive power;
a focusing lens group having negative refractive power and configured to move in an optical axis direction at focusing; and
a final lens group having positive refractive power, wherein
a space between adjacent lens groups changes at zooming,
the first lens group is constituted by one single lens, and
the zoom optical system satisfies a condition expressed by expressions below,
$$1.45 < nd 1 < 1.63$$
$$62.5 < vd 1 < 85.$$
in the expressions,
nd1: refractive index of a medium of the single lens constituting the first lens group at a d line, and
vd1: Abbe number of the medium of the single lens constituting the first lens group at the d line.

2. The zoom optical system according to claim 1, wherein the final lens group moves on an optical axis at zooming.

3. The zoom optical system according to claim 1, wherein the zoom optical system satisfies a condition expressed by an expression below,
$$4.8 < f 1 / ( - f 2 ) < 7.50$$
in the expression,
f1: focal length of the first lens group, and
f2: focal length of the second lens group.

4. The zoom optical system according to claim 1, wherein the zoom optical system satisfies a condition expressed by an expression below,
$$3.8 < f 1 / fMw < 6.$$
in the expression,
f1: focal length of the first lens group, and
fMw: focal length of the middle lens group in a wide-angle end state.

5. The zoom optical system according to claim 1, wherein the zoom optical system satisfies a condition expressed by an expression below,
$$2. < f 1 / ( - fF ) < 4.$$
in the expression,
f1: focal length of the first lens group, and
fF: focal length of the focusing lens group.

6. The zoom optical system according to claim 1, wherein the zoom optical system satisfies a condition expressed by an expression below,
$$1. 10 < f 1 / fR < 1.75$$
in the expression,
f1: focal length of the first lens group, and
fR: focal length of the final lens group.

7. The zoom optical system according to claim 1, wherein the zoom optical system satisfies a condition expressed by an expression below,
$$0.4 < f 2 / fF < 0.65$$
in the expression,
f2: focal length of the second lens group, and
fF: focal length of the focusing lens group.

8. The zoom optical system according to claim 1, wherein the zoom optical system satisfies a condition expressed by an expression below,
$$0. 10 < ( - f 2 ) / fR < 0.35$$
in the expression,
f2: focal length of the second lens group, and
fR: focal length of the final lens group.

9. The zoom optical system according to claim 1, wherein the zoom optical system satisfies a condition expressed by an expression below,
$$0.2 < fMw / fR < 0.4$$
in the expression,
fMw: focal length of the middle lens group in a wide-angle end state, and
fR: focal length of the final lens group.

10. The zoom optical system according to claim 1, wherein the zoom optical system satisfies a condition expressed by an expression below,
$$0.2 < ( - fF ) / fR < 0.65$$
in the expression,
fF: focal length of the focusing lens group, and
fR: focal length of the final lens group.

11. The zoom optical system according to claim 1, wherein the zoom optical system satisfies a condition expressed by an expression below,
$$1. < fw / Bfw < 1.8$$
in the expression,
fw: overall focal length of the zoom optical system in a wide-angle end state, and
Bfw: back focus of the zoom optical system in the wide-angle end state.

12. The zoom optical system according to claim 1, wherein the zoom optical system satisfies a condition expressed by an expression below,
$$0.7 5 < f 1 / TLw < 1.35$$
in the expression,
f1: focal length of the first lens group, and
TLw: optical total length of the zoom optical system in a wide-angle end state.

13. The zoom optical system according to claim 1, wherein the zoom optical system satisfies a condition expressed by an expression below,
$$0.7 < f 1 / TLt < 1.$$
in the expression,
f1: focal length of the first lens group, and
TLt: optical total length of the zoom optical system in a telephoto end state.

14. An optical apparatus comprising the zoom optical system according to claim 1.

15. A method for manufacturing a zoom optical system including, sequentially from an object side, a first lens group having positive refractive power, a second lens group having negative refractive power, a middle lens group including one or two lens groups and having overall positive refractive power, a focusing lens group having negative refractive power and configured to move in an optical axis direction at focusing, and a final lens group having positive refractive power, the method comprising:
disposing the lens groups so that a space between adjacent lens groups changes at zooming; and
disposing the first lens group to be constituted by one single lens that satisfies a condition expressed by expressions below,
$$1.45 < nd 1 < 1.63$$
$$62.5 < vd 1 < 85.$$
in the expressions,
nd1: refractive index of a medium of the single lens constituting the first lens group at a d line, and
vd1: Abbe number of the medium of the single lens constituting the first lens group at the d line.
